(19) United States
(12) Patent Application Publication
(10) Pub. No.: US 2010/0129049 A1
(43) Pub. Date: May 27, 2010

(54) EDITING APPARATUS, CONTROL METHOD OF THE EDITING APPARATUS, AND IMAGE PICKUP APPARATUS

(75) Inventor: Hiroyuki Hasegawa, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/623,079

(22) Filed: Nov. 20, 2009

(30) Foreign Application Priority Data
Nov. 25, 2008 (JP) 2008-300186

(51) Int. Cl. H04N 5/93; H04N 5/225

(52) U.S. Cl. 386/52; 348/207.1; 348/E05.024; 386/E05.003

(57) ABSTRACT

When an external device approaches a communication unit while image data to be edited is edited, the communication unit establishes a connection with the external device by close proximity wireless communication. In response to the establishment of the connection by the close proximity wireless communication, image data is received from another device, and the received image data is incorporated into the image data being edited.

### BACKGROUND OF THE INVENTION

1. Field of the Invention

The present invention relates to an editing apparatus that edits an image, a control method of the editing apparatus, and an image pickup apparatus.

2. Description of the Related Art

A digital still camera and a digital video camera are widely used that can record still image data and moving image data obtained by photographing in a recording medium such as a semiconductor memory.

Many models of the digital still cameras can shoot not only individual still images, but also temporally continuous images such as continuously photographed images and moving images. Similarly, many models of the digital video cameras can shoot not only moving images, but also still images. However, a moving image shooting function of the digital still camera is generally inferior to that of the digital video camera, and a still image shooting function of the digital video camera is inferior to that of the digital still camera. Therefore, for example, in the shooting of an important event such as traveling, a digital still camera is used to shoot still images, and a digital video camera is used to shoot moving images. In many cases, both devices are used in accordance with the intended use.

Conventionally, when images photographed by a plurality of devices are combined to create a set of continuous images, the images are transferred to a personal computer, and edit software is used to perform an edit operation. To edit the images, the user needs to prepare a personal computer and edit software and transfer the images to the personal computer, which may be cumbersome.

Some methods have been proposed for performing an edit operation without using a personal computer. Japanese Patent Laid-Open No. 2006-340381 describes a method in which an arbitrary temporal position in recorded moving image data is designated, a transition from the designated state to a photographic mode is made, and image data obtained by shooting is incorporated into the designated temporal position. Japanese Patent Laid-Open No. 2003-274352 describes a method of automatically inserting a title image prepared in a detachable external recording medium into the current recording position or playback position in content data being recorded or played back.

However, Japanese Patent Laid-Open No. 2006-340381 has problems that an image that is already photographed cannot be incorporated into an arbitrary position in the moving images and that an image photographed by another device cannot be incorporated.

In Japanese Patent Laid-Open No. 2003-274352, images cannot be directly transferred between devices, and the images need to be temporarily transferred to an external recording medium. If a digital still camera and a digital video camera are compliant to a common external recording medium, only the replacement of the external recording medium is necessary. However, if the digital still camera and the digital video camera are not compliant to a common external recording medium, there is a problem that a personal computer, etc., needs to be used to transfer the images to a compliant external recording medium, which is time-consuming.

### SUMMARY OF THE INVENTION

The present invention provides an editing apparatus, a control method of the editing apparatus, and an image pickup apparatus that can solve at least one of the problems described above and that can easily perform an edit operation of incorporating moving images or still image data stored in another device into moving image data.

According to an aspect of the present invention, there is provided an editing apparatus comprising: an editing unit configured to edit data; a communication unit configured to transmit and receive data to and from an external device by close proximity wireless communication; and a detecting unit configured to detect a status of the connection with the external device by the close proximity wireless communication, wherein if the detecting unit detects that the connection with the external device is established while the editing unit edits first data, the communication unit receives second data from the external device, and the editing unit incorporates the second data received by the communication unit into the first data.

Further features of the present invention will become apparent from the following description of exemplary embodiments with reference to the attached drawings.

### BRIEF DESCRIPTION OF THE DRAWINGS

FIG. 1 is a block diagram showing a configuration of an example of an editing apparatus 1 applicable to the present invention.

FIG. 2 is a diagram showing an example of a list screen for selecting moving image data to be edited.

FIG. 3 is a diagram for explaining connection of an editing apparatus and another device according to embodiments of the present invention.

FIG. 4 is a flowchart of an example schematically showing an edit operation according to a first embodiment of the present invention.

FIGS. 5A and 5B are flowcharts of an example showing an image data insertion process in more detail according to the first embodiment of the present invention.

FIGS. 6A and 6B are diagrams showing an example of a menu screen for setting voice input.

FIGS. 7A to 7C are diagrams showing an example of image data edited based on a series of processes according to the first embodiment of the present invention.

FIGS. 8A and 8B are exemplary flowcharts showing an image data insertion process according to a modification example of the first embodiment of the present invention.

FIG. 9 is an example of a flowchart showing an edit operation according to a second embodiment of the present invention.

FIGS. 10A and 10B are diagrams showing an example of a list screen for selecting moving image data to be edited according to the second embodiment of the present invention.

FIG. 11 is a flowchart showing an example of a process of overwrite recording of voice data according to a third embodiment of the present invention.

FIGS. 12A to 12C are diagrams for more specifically explaining providing an overwriting marker to voice data and an overwriting process of voice data according to a series of processes of the third embodiment of the present invention.

FIG. 13 is a block diagram showing a configuration of an example of a digital video camera applicable to a fourth embodiment of the present invention.

### DESCRIPTION OF THE EMBODIMENTS

Exemplary embodiments of the present invention will now be described in detail in accordance with the accompanying drawings.

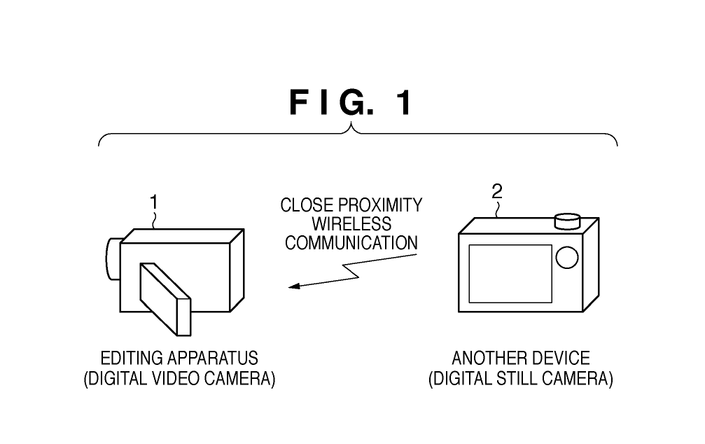

In the embodiments of the present invention, as illustrated in FIG. 1, still image data, moving image data, or voice data stored in another device 2 is transmitted to an editing apparatus 1 by close proximity wireless communication, and an edit process is executed in which the data is incorporated into a desired position of edit target data that is stored in the editing apparatus 1 and that is played back in a time-series manner. More specifically, the editing apparatus 1 attaches a marker to a playback position of edit target data according to timing of the detection of the establishment of connection with the other device 2 in close proximity wireless communication. The marker indicates a position where data transmitted from the other device 2 is incorporated into the edit target data. After the communication with the other device 2 in close proximity wireless communication is disconnected, the data transmitted from the other device 2 is incorporated into the edit target data from the position of the marker.

The edit target data is, for example, moving image data or voice data. In FIG. 1, the editing apparatus 1 is a digital video camera, and the other device 2 is a digital still camera. However, this is an example, and the arrangement is not limited to this example.

In the present specification, the “close proximity wireless communication” denotes wireless communication based on a communication protocol defined by assuming that the communication distance is less than 1 m, particularly, less than several dozen centimeters. Known examples of such a communication protocol include a “vicinity type” non-contact communication protocol with less than about 70 cm communication distance and a “proximity type” non-contact communication protocol with less than about 10 cm communication distance. Specifically, there are standards such as ISO/IEC 15693, ISO/IEC 14434, and ECMA-340 (ISO/IEC 18092).

A wireless communication technique is also known in which a radio wave with 4.48 GHz band center frequency is used, the communication range is limited to several centimeters, and 560 Mbps maximum transfer rate is realized. Such a close proximity wireless communication is characterized by a fast effective transfer rate and is also advantageous in that the device can be downsized and that the weak radio wave allows outdoor use. Furthermore, unintended communication with another device is unlikely to occur because an act of approximating the devices is always required. Therefore, there are advantages that pairing or a certification operation is not necessary, cumbersome setting and security consideration required in conventional wireless techniques are not required, and the connection can be easily made.

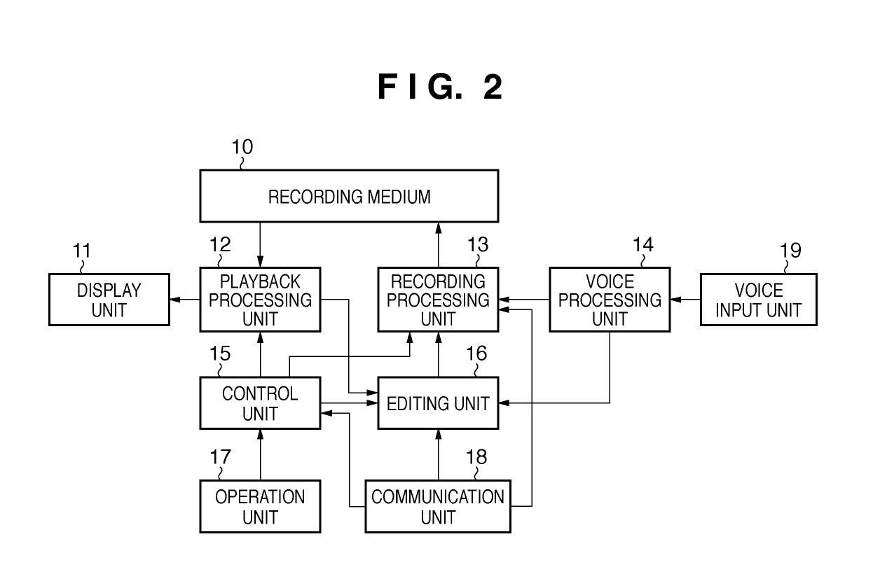

FIG. 2 shows a configuration of an example of the editing apparatus 1 applicable to the present invention. A recording medium 10 is configured to record moving image data, and for example, a hard disk, a non-volatile semiconductor memory, or a recordable optical disk can be applied. Examples of the recording medium 10 are not limited to these, and other types of recording media can be applied as long as the media have a capacity for recording the moving image data and random access is possible.

A control unit 15 includes, for example, a CPU, a ROM, and a RAM and uses the RAM as a work memory to control the components of the editing apparatus 1 in accordance with programs stored in the ROM in advance. An operation unit 17 includes various operation portions for receiving user operations and outputs control signals according to operations to the operation portions. The control unit 15 executes various signal processes according to programs and controls the components of the editing apparatus 1 in accordance with the control signals output from the operation unit 17 to realize operations corresponding to the user operations of the editing apparatus 1.

A voice input unit 19, which is, for example, a microphone, inputs voice from the outside and converts the voice into an analog voice signal. A voice processing unit 14 converts the analog voice signal output from the voice input unit 19 into digital voice data.

A communication unit 18 performs communication by the close proximity wireless communication described above. More specifically, the communication unit 18 includes an antenna for performing the close proximity wireless communication and a transmission/reception circuit that transmits and receives data by the close proximity wireless communication. The communication unit 18 is configured to be able to detect the connection and disconnection status of communication by the close proximity wireless communication, and the detected connection and disconnection status of communication is notified to the control unit 15. The moving image data, the still image data, the voice data, etc., transmitted from another device by the close proximity wireless communication is received by the communication unit 18 and supplied to an editing unit 16 or a recording processing unit 13.

An example of a method for the communication unit 18 to determine the connection and disconnection status of communication will be described. For example, the communication unit 18 can communicate with a device of a connection destination at a certain interval and determine that the communication is disconnected if there is no response from the connection destination device within a certain time. As for the connection of communication, for example, the communication unit 18 can attempt communication when the connection is not established and determine that the communication is connected if there is a response from the connection destination device.

In another example, in close proximity wireless communication in which the power is supplied to the connection destination device by electromagnetic induction, the connection destination device approaches the communication unit 18 if the communication unit 18 is on the power supply side, and the supply of power starts communication. The power supply is terminated as the device gets away from the communication unit 18, and the communication is interrupted.

The editing unit 16 includes a memory, and based on the control of the control unit 15, edits the still image data, the moving image data, and the voice data. More specifically, the playback processing unit 12, the communication unit 18, and the voice processing unit 14 supply the still image data, the moving image data, and the voice data to the editing unit 16. The editing unit 16, for example, develops part or all of the data to be edited and executes an edit process of the still image data, the moving image data, and the voice data on the memory.

The recording processing unit 13 includes an encoder that compresses and encodes the still image data, the moving image data, and the voice data and a recording control unit that controls recording of data to the recording medium 10. More specifically, based on the control of the control unit 15, the recording processing unit 13 compresses and encodes the still image data, the moving image data, and the voice data, applies error correction encoding to the compressed and encoded data, and records the data in the recording medium 10. For example, the recording processing unit 13 applies compression encoding and error correction encoding to the moving image data edited by the editing unit 16 and the still image data, the moving image data, and the voice data received by the communication unit 18 and records the data in the recording medium 10. Similarly, the recording processing unit 13 applies compression encoding and error correction encoding to the voice data supplied from the voice processing unit 14 and records the data in the recording medium 10.

The playback processing unit 12 includes a playback control unit that controls the playback of data recorded in the recording medium 10 and a decoder that decodes the compressed and encoded still image data, moving image data, and voice data. More specifically, based on the control of the control unit 15, the playback processing unit 12 reads out data from the recording medium 10 and plays back the data recorded in the recording medium 10. Based on the control of the control unit 15, the playback processing unit 12 applies a decoding process of the error correction code or compressed code to the data played back from the recording medium 10 to generate playback data.

The moving image data and the still image data generated by the playback processing unit 12 are displayed on, for example, the display unit 11. The display unit 11 can further display in accordance with a display control signal generated by the control unit 15.

To perform an edit operation using the editing apparatus 1 configured this way, the user first operates the operation unit 17 to switch the operation mode of the editing apparatus 1 to an editing mode using the close proximity wireless communication. Hereinafter, the editing mode using the close proximity wireless communication will be called a wireless editing mode. The moving image data to be edited is recorded in the recording medium 10 in advance.

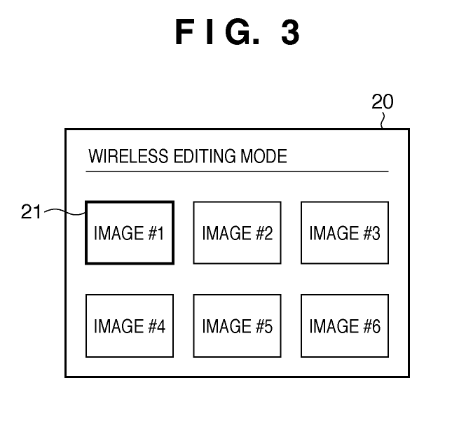

When the operation mode is switched to the wireless editing mode, the display unit 11 displays a list screen 20 for selecting moving image data to be edited as illustrated in FIG. 3 based on the control of the control unit 15. In the list screen 20, for example, predetermined frame images of the moving image data recorded in the recording medium 10 are reduced and listed. The user operates the operation unit 17 and moves a selection cursor 21 to select moving image data to be edited.

A piece of hardware may control the devices, or a plurality of pieces of hardware may share the processes to control the entire devices. The control unit 15 and the editing unit 16 do not have to be different pieces of hardware. For example, a CPU may be configured to realize functions of both the control unit 15 and the editing unit 16.

### First Embodiment

An edit process according to a first embodiment of the present invention will now be described. To avoid complication, still image data or moving image data transmitted from a connection destination device will be called image data hereinafter.

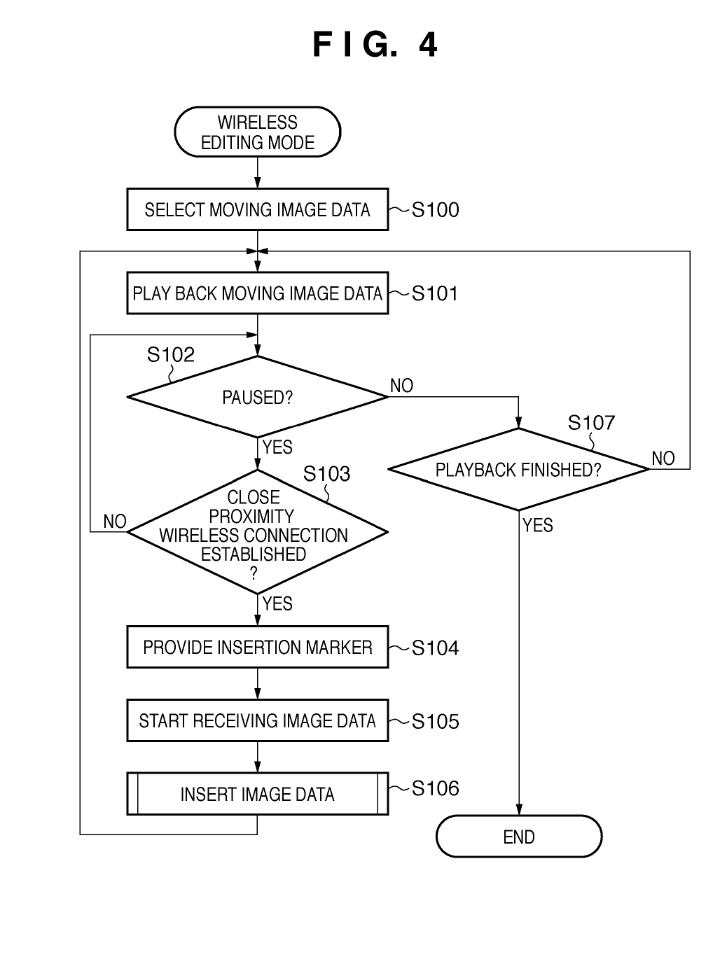

FIG. 4 is an example of a flowchart schematically showing an edit operation of the present first embodiment. The control unit 15 controls the components of the editing apparatus 1 according to programs to execute the processes in the flowchart of FIG. 4.

In S100, if the moving image data to be edited is selected as described above, the process moves to S101. In S101, the playback processing unit 12 reads out the selected moving image data from the recording medium 10 and executes a playback process such as a decoding process of an error correction code and a compressed code. The display unit 11 displays the played back moving image data as moving images.

In the following S102, whether the playback of the moving image data is paused is determined. For example, if a user operation to the operation unit 17 selects a pause, the playback of the moving image data pauses. If it is determined that the playback is not paused, the process moves to S107, and whether the playback of the moving image data is finished is determined. If it is determined that the playback is finished, a series of processes ends. If it is determined that the playback is not finished, the process returns to S101, and the playback of the moving image data continues.

On the other hand, if it is determined that the playback of the moving image data is paused in S102, the process moves to S103 and waits for the establishment of the connection of the close proximity wireless communication. If the connection is not established, the process returns to S102.

An establishment process of connection by the close proximity wireless communication in S103 will be described in more detail. In S103, the editing apparatus 1 enters a state of periodically monitoring whether there is a connection request by the close proximity wireless communication from the other device 2.

For example, based on an operation by the user, the other device 2 selects, in advance, image data to be incorporated into the moving image data to be edited which is selected by the editing apparatus 1. Hereinafter, the image data to be incorporated into the moving image data to be edited will be called insertion image data. The other device 2 as a connection destination device transmits the selected insertion image data to the editing apparatus 1 by the close proximity wireless communication.

The other device 2 is switched to a state in which data transmission by the close proximity wireless communication is possible, that is, a state in which connection requests of the close proximity wireless communication are periodically transmitted. A communication unit based on the close proximity wireless communication of the other device 2 is approximated to the communication unit 18 of the editing apparatus 1, within the communication range. When the communication unit 18 detects a connection request from the other device 2, the editing apparatus 1 sets connection information of the other device 2 to, for example, the communication unit 18 and returns a connection admission to the other device. After receiving the connection admission, the other device 2 sets connection information of the editing apparatus 1 to the communication unit in the same way.

The close proximity wireless communication is one-to-one communication. Therefore, the communication unit does not establish connection with another device when connection with a device is already established even if the other device that transmits a connection request approaches the communication unit. Furthermore, connection is not established even if the communication unit of the other device enters the communication range based on the close proximity wireless communication unless a connection request is detected.

In S103, if the connection by the close proximity wireless communication is established between the editing apparatus 1 and the other device 2, the process moves to S104. In S104, an insertion marker as a marker indicating the paused playback position is provided to the moving image data in which the playback is paused in the editing apparatus 1. The insertion marker indicates the paused playback position of the moving image data with, for example, a playback time from the top of the moving image data. Alternatively, the insertion marker may indicate the paused playback position with, for example, the byte position of the moving image data. The insertion image data received from the other device 2 connected by the close proximity wireless communication is inserted into the position indicated by the insertion marker. The insertion marker is provided by, for example, the editing unit 16 and is temporarily stored in a RAM included in the control unit 15.

The process moves to the following S105, and the communication unit 18 starts receiving the image data transmitted from the other device 2. For example, when providing of the insertion marker in S104 is completed, the communication unit 18 notifies the other device 2 by the close proximity wireless communication that the reception of the insertion image data is possible. After receiving the notification, the other device 2 starts transmitting the insertion image data. The received insertion image data is sequentially recorded in the recording medium 10 through, for example, a buffer memory not shown included in the recording processing unit 13.

In the following S106, the received insertion image data is inserted into the position of the insertion marker of the selected moving image data to be edited, and the received insertion image data is incorporated into the moving image data to be edited. Details of the insertion process of the image data in S106 will be described below. When the insertion process of the image data in S106 is completed, the process returns to S101, and the playback of the moving image data is restarted from, for example, the paused position.

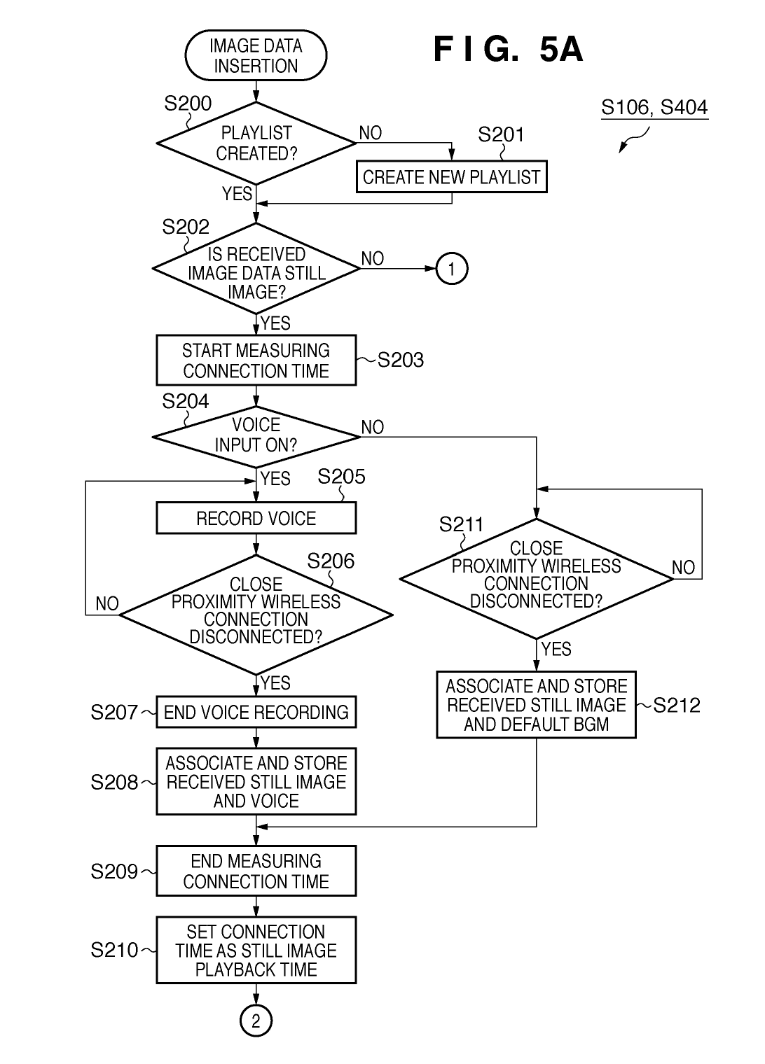

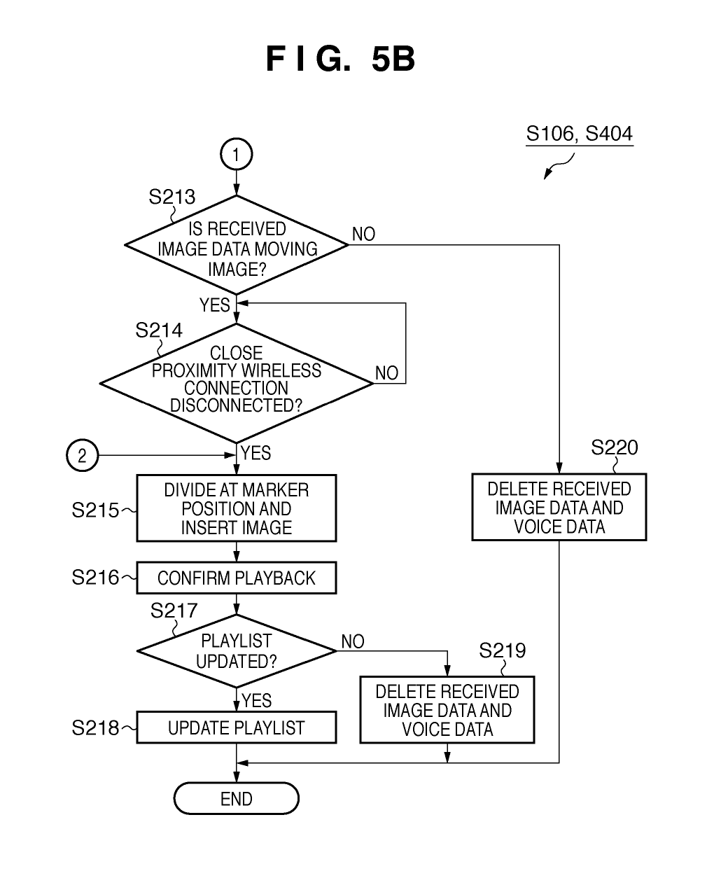

FIGS. 5A and 5B are an example of a flowchart showing the image data insertion process in S106 of FIG. 4 in more detail. The control unit 15 controls the components of the editing apparatus 1 according to the programs to execute the process of the flowchart of FIGS. 5A and 5B.

In the present first embodiment, a playlist is created to insert the image data. The playlist is a list describing information for managing the order of playback of the moving image data and is, for example, a list lining up the photographed scenes in the order of playback. In a more specific example, the playlist describes the playback time and the position on the data (for example, byte position) in association with each scene in the moving image data and describes the order of playback of the scenes. The control unit 15 controls the recording medium 10 according to the playlist through the playback processing unit 12 and plays back the moving image data recorded in the recording medium 10.

The use of the playlist can perform edit processing, such as dividing, moving, and deleting of the scenes, without modifying the original moving image data. The playlist is associated with corresponding moving image data and stored, for example, in the recording medium 10 that records the moving image data.

In S200, the control unit 15 determines whether a playlist for the moving image data to be edited selected in S100 is created. If the control unit 15 determines that the playlist is already created, the process moves to S202. On the other hand, if the control unit 15 determines that the playlist is not created, the process moves to S201, and for example, the editing unit 16 creates a new playlist based on the information of the selected moving image data. The newly created playlist or the already created playlist at least describes information for playing back the moving image data to be edited from the top and information indicating the insertion marker.

In the following S202, the control unit 15 determines whether the data transmitted from the other device 2 and started to be received in S105 is still image data.

The determination of whether the received data is still image data is possible, for example, by starting to receive the data after the editing apparatus 1 selects the image type of data to be received. Alternatively, if the insertion image data is transmitted as data stored in a file, whether the data is still image data can be determined based on the file name extension. Furthermore, the other device 2 may transmit the insertion image data and metadata indicating the attributes of the insertion image data, and the editing apparatus 1 may determine whether the data is still image data based on the received metadata.

If it is determined in S202 that the received data is still image data, the process moves to S203. In S203, the other device 2 is connected to the editing apparatus 1 using the close proximity wireless communication and starts measuring the connected time. More specifically, if the received image data is still image data, the other device 2 measures the time that the connection by the close proximity wireless communication is continuing to determine the playback time of the still image data. In other words, the time from the establishment to the disconnection of the connection of the close proximity wireless communication is set as the length of the playback time of the received still image data.

Whether the connection of the close proximity wireless communication is continuing is checked based on whether there is a response from the connection destination after the communication unit 18 of the editing apparatus 1 periodically transmits connection confirmation requests to the connection destination. More specifically, the connection is determined to be continuing if a response from the other device 2 is received within a predetermined time from the transmission of the connection confirmation requests. If the response is not received after the predetermined time, the other device 2 is determined to be out of the communication range, and the set connection destination information is deleted. Or, the editing apparatus 1 deletes the set connection destination information when receiving a disconnect request from the other device 2. The deletion of the information of the set connection destination is assumed as a disconnection of the connection by the close proximity wireless communication.

When the measurement of the connection time is started in S203, the process moves to S204, and whether the voice input is set to ON (valid) is determined.

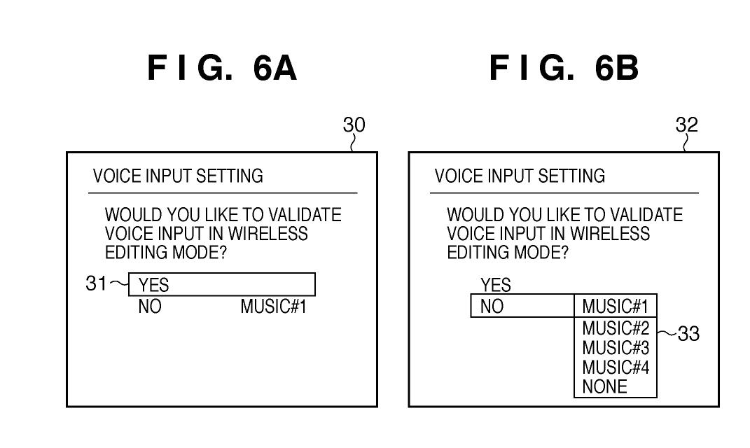

The voice input is set in advance before the edit operation started in the flowchart of FIG. 4. FIG. 6A shows an example of a menu screen 30 for setting ON/OFF of the voice input. The control unit 15 causes the display unit 11 to display the menu screen 30, such as a user operation to the operation unit 17. The user operates a selection cursor 31 by the operation unit 17 in accordance with the menu screen 30 and sets ON and OFF (invalid) of the voice input.

The voice set with ON/OFF of input is used as BGM in the playback period of still image data during the playback of the moving image data inserted with the still image data. When the selection cursor 31 is moved to “No” in the menu screen 30 to turn off the voice input, default BGM during the playback of the still image data can be selected. For example, when the selection cursor 31 is moved to “No”, the screen is switched to a menu screen 32 as shown in FIG. 6B, and default BGM can be selected and set from a list 33. The voice data for playing back the default BGM is recorded in advance, for example, in the recording medium 10 and registered to be selected from the menu screen 32.

If it is determined in S204 that the voice input is set to ON, the process moves to S205, and the voice recording is started. For example, the voice processing unit 14 converts the voice inputted to the voice input unit 19 into a digital voice signal, and the signal is temporarily stored in a memory not shown included in the voice processing unit 14. Alternatively, the digital voice signal can be supplied to the recording processing unit 13 and recorded in the recording medium 10 after compression encoding and attachment of an error correction code. In the following S206, whether the connection of the close proximity wireless communication is disconnected is determined. If it is determined that the close proximity wireless communication is connected, the process returns to S205, and the recording of voice continues.

On the other hand, if it is determined in S206 that the connection of the close proximity wireless communication is disconnected, the process moves to S207, and the recording of voice ends. The process then moves to S208, the recorded voice data and the still image data received from the other device 2 are associated and recorded in the recording medium 10. The information indicating the association between the voice data and the still image data is temporarily stored in, for example, the RAM included in the control unit 15 or the recording medium 10. After the recording of the voice data in the recording medium 10 finishes, the process moves to S209.

On the other hand, if it is determined in S204 described above that voice input is set to OFF, the process moves to S211, and whether the connection of the close proximity wireless communication is disconnected is monitored. If it is determined that the connection of the close proximity wireless communication is disconnected, the process moves to S212.

In S212, BGM for use in the playback of the still image data is selected from the default BGM. For example, desired BGM is selected from the list 33 on the menu screen 32 shown in FIG. 6B described above. The still image data received from the other device 2 is associated with the selected BGM and recorded in the recording medium 10.

In the following S209, the measurement of the connection time by the close proximity wireless communication started in S203 described above ends. In the following S210, the connection time based on the close proximity wireless communication obtained as a measurement result is set as the time of playing back the still image data, and the process moves to S215.

Although the time of the connection with the other device 2 using the close proximity wireless communication is set as the playback time of the still image data in the above description, the arrangement is not limited to this example. For example, the default playback time may be set, or the user may operate the operation unit 17 to set the playback time based on the menu screen, etc. In that case, if the voice input is set to ON, the time for recording the voice for a set time is arranged after the confirmation of the disconnection of the close proximity wireless communication in S206, and the recorded voice data is associated with the received still image data and recorded.

The foregoing is the process when the still image data is received from the other device 2. A case in which it is determined in S202 that the data received from the other device 2 is not still image data will now be described.

If it is determined in S202 described above that the data received from the other device 2 is not the still image data, the process moves to S213. In S213, whether the data received from the other device 2 is moving image data is determined.

The determination of whether the received insertion image data is moving image data is possible, for example, by starting to receive the image data after the editing apparatus 1 selects the image type of insertion image data to be received in advance. Alternatively, if the insertion image data is transmitted as data stored in a file, whether the data is still image data can be determined based on the file name extension. Furthermore, the other device 2 may transmit the insertion image data and metadata indicating the attributes of the insertion image data, and the editing apparatus 1 may determine whether the data is moving image data based on the received metadata.

If it is determined in S213 that the received data is not moving image data, the process moves to S220, and the received data is deleted. A series of processes based on the flowcharts of FIGS. 5A and 5B ends, and the process returns to S101 of FIG. 4. This is because the received data is considered not effective for editing if the data is neither still image data nor moving image data.

On the other hand, if it is determined in S213 that the received data is moving image data, the process moves to S214, and whether the connection by the close proximity wireless communication is disconnected is monitored. If it is determined that the close proximity wireless communication is disconnected, the process moves to S215.

If the received data is moving image data, the editing apparatus 1 receives the moving image data played back in the other device 2 as stream data in real time after the establishment of connection by the close proximity wireless communication in S103 until the disconnection is detected in S214. Alternatively, the moving image data may be received as a file from the other device 2. When the transmission of the insertion image data from the other device 2 is completed, the completion on the display unit 11 can be displayed.

In S215, on the playlist, the moving image data to be edited is divided at the position of the insertion marker provided in S104 of FIG. 4. The insertion image data (still image data or moving image data) received by the other device 2 is inserted into the divided position on the playlist.

For example, the insertion image data is associated with the insertion marker in the playlist, and the information of the insertion image data is described. For example, the information is described in the playlist so that the insertion image data is played back when the playback of the moving image data to be edited reaches the position of the insertion marker, and the moving image data to be edited is played back from the position of the insertion marker when the playback of the insertion image data is finished.

When the division of the moving image data to be edited and the insertion of the insertion image data into the divided position are finished, the process moves to S216. In S216, the user is prompted to confirm the playback of the playlist edited in S215 described above. More specifically, the playback processing unit 12 plays back the series of moving image data and displays the data on the display unit 11 in accordance with the control of the control unit 15 based on the playlist edited in S215. In the playback display, all of the series of moving image data may be played back in the playback display, or only a certain time around the position of the inserted insertion image data may be selectively played back and displayed.

When the playback confirmation in S216 is finished, the process moves to S217, and whether to update the playlist with the edit content with which the playback is confirmed is determined. For example, when the user operation to the operation unit 17 is suspended and the user operation instructs an update, the playlist is determined to be updated, and the process moves to S218. In S218, the update of the playlist is determined, and for example, the updated playlist is recorded in the recording medium 10.

On the other hand, if it is determined not to update the playlist in S217, the process moves to S219. In S219, the insertion image data and the voice data associated with the insertion image data are deleted. At this point, the insertion marker may also be deleted from the playlist.

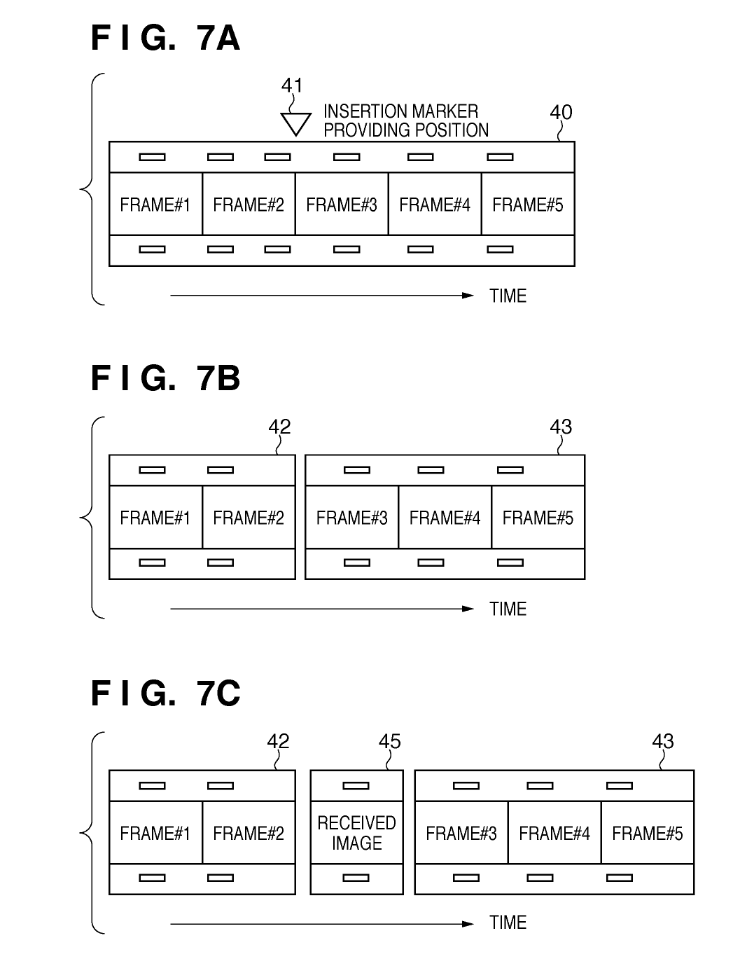

FIGS. 7A to 7C illustrate an example of image data edited based on the series of processes described above. Moving image data 40 illustrated in FIG. 7A is moving image data to be edited included in the editing apparatus 1 (S100 of FIG. 4). In S102 of FIG. 4, it is assumed that the playback of the moving image data 40 is paused between a frame #2 and a frame #3.

When a connection with the other device 2 by the close proximity wireless communication is established in this condition, an insertion marker 41 is provided between the frame #2 and a frame #3 as illustrated in FIG. 7A (S104 of FIG. 4). When the reception of the insertion image data from the other device 2 is finished, the moving image data 40 is divided into moving image data 42 and moving image data 43 across the insertion marker 41 on the playlist as illustrated in FIG. 7B. As illustrated in FIG. 7C, insertion image data 45 received from the other device 2 is inserted into the position of the insertion marker 41 (S214 of FIG. 5B).

If the insertion image data 45 is still image data, the playlist can be created in the still image file format as it is. For example, the data can be described so that the insertion image data 45 is continuously displayed on the playlist for a playback time set in S210. In that case, for example, a decoder (playback processing unit 12) can repeatedly and continuously output the still image data at frame timing during a designated playback time to play back the still image data as moving images.

Alternatively, in consideration of the playback efficiency, the still image data may be converted into a moving image file format to create a photo movie, and the photo movie may be inserted into the position of the insertion marker 41. The photo movie denotes data in which still image data is converted into one piece of moving image data including a predetermine playback time. For example, the editing unit 16 duplicates the still image data to form frames corresponding to the playback time set in S210 and generates moving image data in an amount of the playback time from the duplicated still image data.

The format (such as image size and aspect ratio) of the insertion image data may be different from the format of the moving image data to be edited. In that case, the editing unit 16 can convert the format of the insertion image data according to the format of the moving image data to be edited. Alternatively, the edit processing may be canceled if the formats of the insertion image data and the moving image data to be edited are different.

In the above description of S102 of FIG. 4, if it is determined that the playback of the moving image data to be edited is paused, the establishment of the connection of the close proximity wireless communication is suspended in S103. However, the arrangement is not limited to this example. More specifically, the editing apparatus 1 can pause the playback of the moving image data to be edited when the connection of the close proximity wireless communication with the other device 2 is established. And the insertion marker indicating the playback position of the paused edit target data is provided to the moving image data to be edited. In this way, the user can just approximate the other device 2 to the editing apparatus 1 to designate the edit position and insert the image data transmitted from the other device 2 into the edit position.

As described, according to the first embodiment of the present invention, an insertion marker indicating the position for inserting the image data included in the other device 2 into the moving image data included in the editing apparatus 1 is automatically set by approximating the other device 2 to the editing apparatus 1. As the insertion marker is set, the reception of the image data transmitted from the other device 2 starts. Therefore, an operation of inserting the image data included in the other device 2 into the moving image data included in the editing apparatus 1 can be easily performed.

Although the editing apparatus 1 is hardware having dedicated functions in the description, the arrangement is not limited to this example. For example, the editing apparatus 1 may have a close proximity wireless communication function and may be a personal computer installed with edit software for executing the processes described above.

### Modification Example of First Embodiment

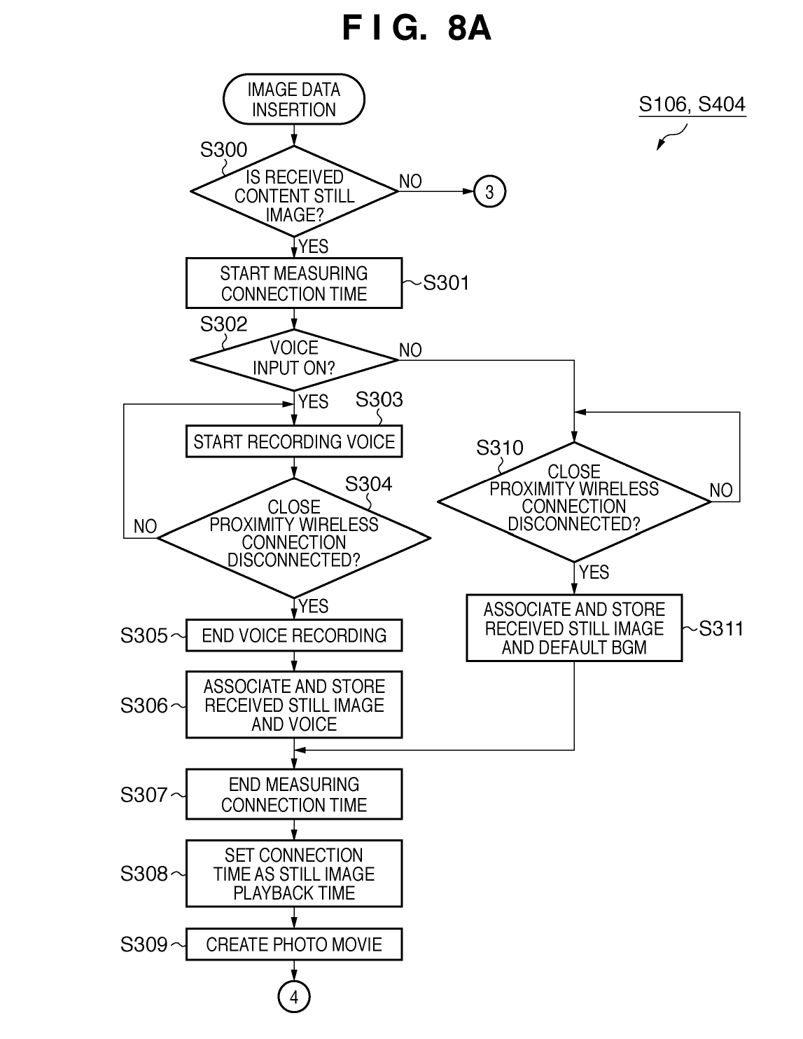

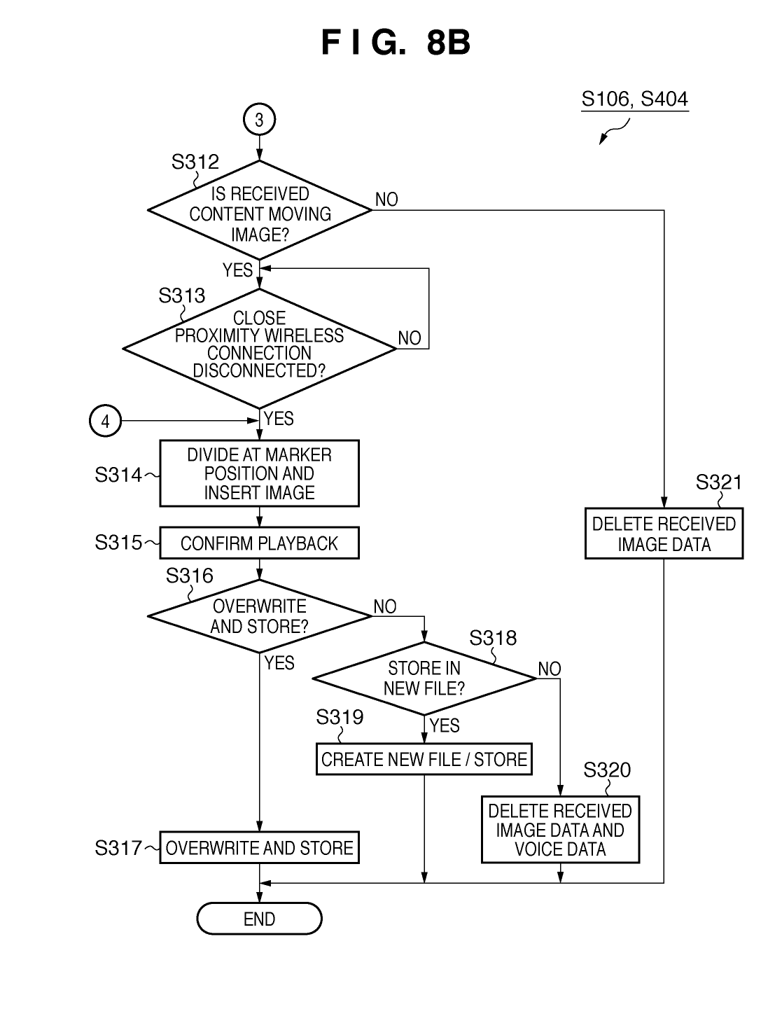

A modification example of the first embodiment of the present invention will now be described. In the present modification example, the moving image data to be edited is directly edited without using a playlist. FIGS. 8A and 8B are exemplary flowcharts applying an image data insertion process of the present modification example to S106 of FIG. 4 described above. The control unit 15 controls the components of the editing apparatus 1 according to programs to execute the processes in the flowcharts of FIGS. 8A and 8B.

In S300, the control unit 15 determines whether the data that is transmitted from the other device 2 and that is started to be received in S105 of FIG. 4 is still image data. The determination method of whether the received data is still image data is common to the method described in S202 of FIG. 5A, and the description will not be repeated.

If it is determined in S300 that the received data is still image data, the process moves to S301. In S301, the measurement of time that the other device 2 is connected to the editing apparatus 1 using the close proximity wireless communication is started. The confirmation method of whether the connection of the close proximity wireless communication is continuing is common to the method described in S203 of FIG. 5A, and the description will not be repeated.

When the measurement of the connection time is started in S301, the process moves to S302, and whether the voice input is set to ON (valid) is determined. If it is determined in S302 that the voice input is set to ON, the process moves to S303, and voice recording starts. In the following S304, whether the connection of the close proximity wireless communication is disconnected is determined. If it is determined that the close proximity wireless communication is connected, the process returns to S303, and the recording of voice continues.

On the other hand, if it is determined in S304 that the connection of the close proximity wireless communication is disconnected, the process moves to S305, and the recording of voice ends. The process then moves to S306, the recorded voice data and the still image data received from the other device 2 are associated and recorded in the recording medium 10. When the recording of the voice data in the recording medium 10 is finished, the process moves to S308.

On the other hand, if it is determined in S302 described above that the voice input is set to OFF, the process moves to S310, and whether the connection of the close proximity wireless communication is disconnected is monitored. If it is determined that the connection of the close proximity wireless communication is disconnected, the process moves to S311, and BGM for use in the playback of the still image data is selected from the default BGM. The still image data received from the other device 2 is associated with the selected BGM and recorded in the recording medium 10. When the still image data is recorded in the recording medium 10, the process moves to S307.

In S307, the measurement of the connection time by the close proximity wireless communication started in S301 ends. In the following S308, the connection time by the close proximity wireless communication obtained as a measurement result is set as the time for playing back the still image data, and the process moves to S309.

In S309, the control unit 15 controls the editing unit 16 to generate a photo movie of the still image data received from the other device 2 and records the photo movie in the recording medium 10. The playback time of the photo movie is, for example, the playback time set in S308. When the photo movie is generated, the process moves to S314.

If it is determined in S300 described above that the data received from the other device 2 is not still image data, the process moves to S312. In S312, whether the data received from the other device 2 is moving image data is determined. The determination method of whether the received data is moving image data is common to the method described in S213 of FIG. 5B, and the description will not be repeated.

If it is determined in S312 that the received data is not moving image data, the process moves to S321, and the received data is deleted. The series of processes of the flowcharts of FIGS. 8A and 8B end, and the process returns to S101 of FIG. 4.

On the other hand, if it is determined in S312 that the received data is moving image data, the process moves to S313, and whether the connection by the close proximity wireless communication is disconnected is monitored. If it is determined that the close proximity wireless communication is disconnected, the process moves to S314.

If the received data is moving image data, the editing apparatus 1 receives the moving image data played back by the other device 2 in real time as stream data. The moving image data is received after the establishment of the connection by the close proximity wireless communication in S103 until the detection of the disconnection in S313. Alternatively, the moving image data may be received as a file from the other device 2.

In S314, the moving image data to be edited is divided at the position of the insertion marker provided in S104 of FIG. 4, and the insertion image data received from the other device 2 is inserted into the divided position. For example, the moving image data to be edited is divided at the insertion marker position to generate two pieces of moving image data. The insertion image data, that is, the moving image data or the photo movie created in S309, received from the other device 2 is inserted between the two pieces of moving image data to combine the entire data and form one piece of moving image data. In this way, the data received from the other device 2 is incorporated into the moving image data to be edited.

The moving image data to be edited and the moving image data received from the other device 2 (or the photo movie created in S309) are duplicated on the recording medium 10 or the RAM included in the control unit 15, etc., and the process of S314 is applied to the duplicated data.

When the insertion process of the image data to the moving image data to be edited is finished in S314, the process moves to S315. In S315, the series of moving image data edited and created in S314 is played back and displayed on the display unit 11, and the user is prompted to confirm the edit content. In the playback display, all of the series of moving image data may be played back, or a certain time around the position of the inserted image data may be played back.

When the playback display in S315 is finished, the process moves to S316, and the process waits for the selection of whether to overwrite the original moving image data file to be edited with the edit content in which the playback is confirmed. For example, if an operation for overwriting is performed for the operation unit 17, the process moves to S317, and the moving image data used for the playback confirmation in S315 is used to overwrite the file of the moving image data to be edited recorded in the recording medium 10.

On the other hand, if the user operation selects not to overwrite in S316, the process moves to S318. In S318, the process waits for the selection of whether to newly create a moving image data file with the edit content in which the playback is confirmed in S315. For example, if an operation for creating a new file is performed for the operation unit 17, the process moves to S319. In S319, the new moving image data file is created based on the moving image data used in the playback confirmation in S315, and the file is recorded in the recording medium 10.

If it is selected not to create a new file in S318, the process moves to S320, and the insertion image data and the voice data associated with the insertion image data are deleted from the recording medium 10.

As described, according to the first embodiment of the present invention, an insertion marker indicating the position for inserting the image data included in the other device 2 into the moving image data included in the editing apparatus 1 is automatically set by approximating the other device 2 to the editing apparatus 1. As the insertion marker is set, the reception of the image data transmitted from the other device 2 starts. Therefore, an operation of inserting the image data included in the other device 2 into the moving image data included in the editing apparatus 1 can be easily performed.

Although the editing apparatus 1 is hardware having dedicated functions in the description, the arrangement is not limited to this example. For example, the editing apparatus 1 may have a close proximity wireless communication function and may be a personal computer installed with edit software for executing the processes described above.

### Second Embodiment

A second embodiment of the present invention will now be described. The present second embodiment is an example in which the insertion image data received from the other device 2 is inserted at the top or end of the moving image data to be edited. Since the processes of the present second embodiment can be implemented by the editing apparatus 1 described with reference to FIG. 1, configurations that can implement the present second embodiment will not be repeated.

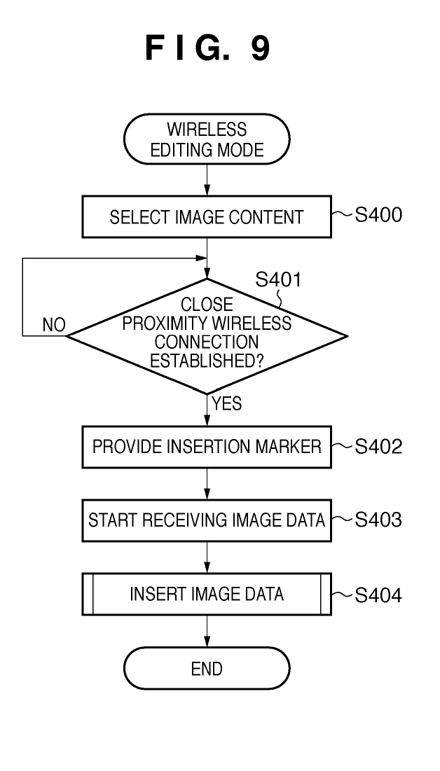

FIG. 9 is an example of a flowchart showing an edit operation according to the present second embodiment. The control unit 15 controls the components of the editing apparatus 1 according to programs to execute the processes in the flowchart of FIG. 9.

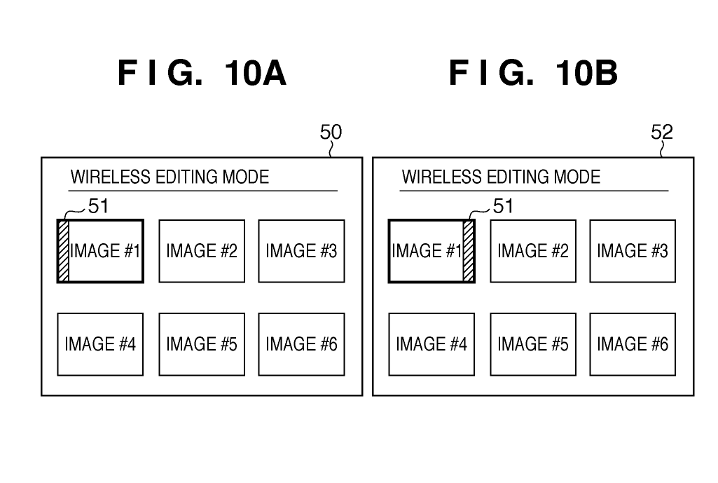

If the operation mode of the editing apparatus 1 is switched to the wireless editing mode, a list screen 50 illustrated in FIG. 10A or 10B is displayed on the display unit 11 in S400. Like the list screen 20 described with reference to FIG. 2, the list screen 50 is formed by reducing and listing predetermined frame images of the moving image data recorded in the recording medium 10. The user operates the operation unit 17 and moves a selection cursor 51 to select moving image data to be edited and the insertion position of the insertion image data received from the other device 2.

In the example of FIGS. 10A and 10B, the selection cursor 51 is displayed on the left margin or the right margin of the selected reduced image. The display of the selection cursor 51 on the left margin of the reduced image as in FIG. 10A indicates that the received image data will be inserted at the top of the moving image data indicated by the reduced image (moving image data #1 in the example). In the state of FIG. 10A, if the user operates the operation unit 17 to transmit the selection cursor 51 to the next, the selection cursor 51 moves to the right margin of the reduced image as illustrated in FIG. 10B. The display of the selection cursor 51 on the right margin of the reduced image indicates that the received image data will be inserted at the end of the moving image data indicated by the reduced image. When the operation unit 17 is further operated to deliver the selection cursor 51, the selection cursor 51 sequentially moves to the left margin of the reduced image indicating moving image data #2, the right margin of the reduced image, the left margin of the next reduced image, and so forth.

The list screen 50 shown in FIGS. 10A and 10B is just an example, and the insertion position of the insertion image data may be designated with other methods such as displaying the selection cursor 51 above and below the reduced images.

When the moving image data to be edited and the insertion position of the insertion image data are selected in S400, the process moves to S401, and the process waits for the establishment of the connection of the close proximity wireless communication. The waiting process of the connection establishment of the close proximity wireless communication in S401 is common to the process in S103 described in FIG. 4, and detailed description will not be repeated.

When the connection of the editing apparatus 1 and the other device 2 by the close proximity wireless communication is established in S401, the process moves to S402. In S402, the insertion marker indicating the position selected in S400 is provided to the moving image data to be edited. In the present second embodiment, an insertion marker indicating the top or end of the moving image data is provided.

The process moves to S403, and the communication unit 18 starts receiving the insertion image data transmitted from the other device 2. In the following S404, the received insertion image data is inserted into the position of the insertion marker of the selected moving image data to be edited. The insertion process of the insertion image data of S404 can be executed by a process common to the process described in the flowchart of FIGS. 5A and 5B or FIGS. 8A and 8B, and the detailed description will not be repeated.

As described, according to the second embodiment of the present invention, an insertion marker indicating the position for inserting the image data included in the other device 2 into the moving image data included in the editing apparatus 1 is automatically set by approximating the other device 2 to the editing apparatus 1. As the insertion marker is set, the reception of the image data transmitted from the other device 2 starts. Therefore, an operation of inserting the image data included in the other device 2 into the moving image data included in the editing apparatus 1 can be easily performed.

Although the editing apparatus 1 is hardware having dedicated functions in the description, the arrangement is not limited to this example. For example, the editing apparatus 1 may have a close proximity wireless communication function and may be a personal computer installed with editing software for executing the processes described above.

### Third Embodiment

A third embodiment of the present invention will now be described. In the present third embodiment, so-called dubbing is performed in which voice data received from the other device 2 overwrites voice data recorded in the editing apparatus 1 in association with the moving image data from a designated position. Since the processes of the present third embodiment can be implemented by the editing apparatus 1 described with reference to FIG. 1, configurations that can implement the present third embodiment will not be repeated.

In the present third embodiment, a digital still camera that has a recording function, a so-called IC recorder that records voice data in a semiconductor memory, etc., can be applied as the other device 2 that transmits data to the editing apparatus 1 by the close proximity wireless communication.

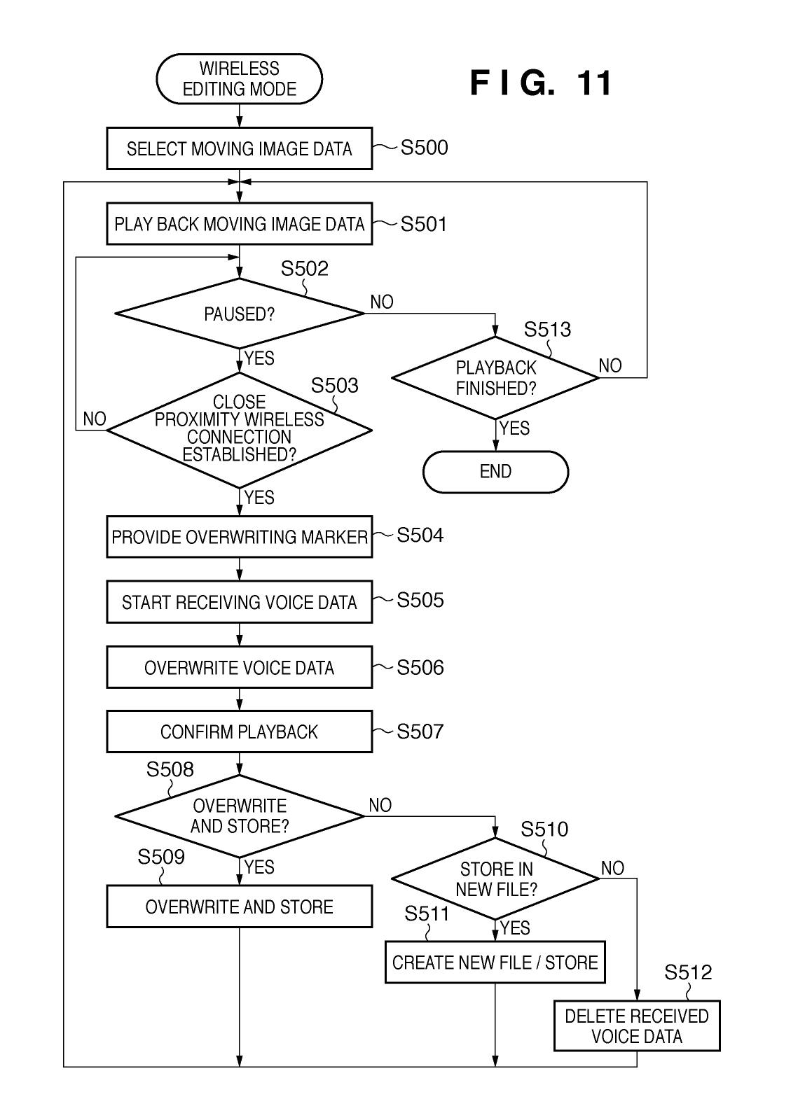

FIG. 11 is a flowchart showing an example of a process of overwrite recording of voice data according to the present third embodiment. The control unit 15 controls the components of the editing apparatus 1 according to programs to execute the processes in the flowchart of FIG. 11.

In the following description, the recording medium 10 of the editing apparatus 1 records moving image data to be edited and records voice data to be played back in synchronous with the moving image data. The voice data is associated with the moving image data.

When the operation mode is switched to the wireless editing mode, the control unit 15 controls the display unit 11 to display the list screen 20 for selecting moving image data to be edited as illustrated in FIG. 2. The user operates the operation unit 17 and moves the selection cursor 21 to select moving image data to be edited.

When the moving image data to be edited is selected in S500 as described above, the process moves to S501. In S501, the playback processing unit 12 reads out the selected moving image data and the voice data associated with the moving image data from the recording medium 10. The moving image data read out from the recording medium is applied with a playback process, such as a decoding process of an error correction code and a compressed code, and displayed on the display unit 11. The playback processing unit 12 decodes the error correction code and the compressed code in the voice data read out from the recording medium 10, and the voice data is output from a speaker, etc., through an output voice processing unit not shown. The voice data is also stored in a memory not shown included in the editing unit 16.

In the following S502, whether the playback of the moving image data and the voice data is paused is determined. For example, if a user operation to the operation unit 17 selects a pause, the playback of the moving image data and the voice data pauses. If it is determined that the playback is not paused, the process moves to S513, and whether the playback of the moving image data and the voice data is finished is determined. If it is determined that the playback is finished, a series of processes ends. On the other hand, if it is determined that the playback is not finished, the process returns to S501, and the playback of the moving image data and the voice data continues.

On the other hand, if it is determined in S502 that the playback of the moving image data and the voice data is paused, the process moves to S503, and the process waits for the establishment of the connection of the close proximity wireless communication. If the connection is not established, the process returns to S502. More specifically, in S503, the editing apparatus 1 enters a state of periodically monitoring whether there is a connection request by the close proximity wireless communication from the other device 2.

Before the process of the flowchart of FIG. 11, the other device 2 selects voice data for overwriting the voice data corresponding to the moving image data selected in the editing apparatus 1 in advance. The other device 2 transmits the selected voice data to the editing apparatus 1 by the close proximity wireless communication. Hereinafter, the voice data transmitted from the other device 2 to the editing apparatus 1 for the dubbing process will be called dubbing voice data.

In S503, when the connection of the editing apparatus 1 and the other device 2 by the close proximity wireless communication is established, the process moves to S504. In S504, an overwriting marker indicating the paused playback position is provided to the paused moving image data and voice data. The voice data received from the other device 2 connected by the close proximity wireless communication is overwritten and incorporated from the position indicated by the overwriting marker. The overwriting marker is temporarily stored, for example, in the RAM included in the control unit 15.

The process moves to the following S505, and the communication unit 18 starts receiving dubbing voice data transmitted from the other device 2. The received dubbing voice data is sequentially stored, for example, in the memory included in the playback processing unit 12. For example, when the providing of the overwriting marker in S504 is completed, the communication unit 18 notifies the other device 2 by the close proximity wireless communication that the reception of the dubbing voice data is possible. After receiving the notification, the other device 2 starts transmitting the selected dubbing voice data.

In the following S506, the received dubbing voice data is overwritten from the position of the overwriting marker provided to the selected moving image data and voice data to be edited. For example, the dubbing voice data received by the communication unit 18 is supplied to the playback processing unit 12, the compressed code is decoded, and the data is supplied to the editing unit 16. The editing unit 16 overwrites the voice data that is read out from the recording medium 10 and that is stored in the memory included in the editing unit 16 by the supplied dubbing voice data from the position indicated by the overwriting marker.

When the voice data is overwritten, the process moves to S507, and the user is prompted to confirm the edit content. More specifically, in S507, a series of moving image data and voice data edited in S506 are played back, the moving image data is displayed on the display unit 11, and the voice data is output from a speaker not shown. In the playback for the confirmation, all of the series of moving images and voice data may be played back, or a certain time around the overwritten voice data may be played back.

When the playback display in S507 is finished, the process moves to S508, and the process waits for the selection of whether to overwrite the original voice data file with the edit content in which the playback is confirmed. For example, if an operation for overwriting is operated for the operation unit 17, the process moves to S509, and the voice data used for the playback confirmation in S507 is used to overwrite the file of the voice data to be edited that is recorded in the recording medium 10.

On the other hand, if the user operation selects not to overwrite in S508, the process moves to S510. In S510, the process waits for the selection of whether to newly create a voice data file with the edit content in which the playback is confirmed in S507. For example, if an operation for creating a new file is performed for the operation unit 17, the process moves to S511. In S511, the new voice data file is created based on the voice data used in the playback confirmation in S507, and the file is recorded in the recording medium 10.

If it is selected not to create a new file in S510, the process moves to S512, and the dubbing voice data received from the other device 2 is deleted.

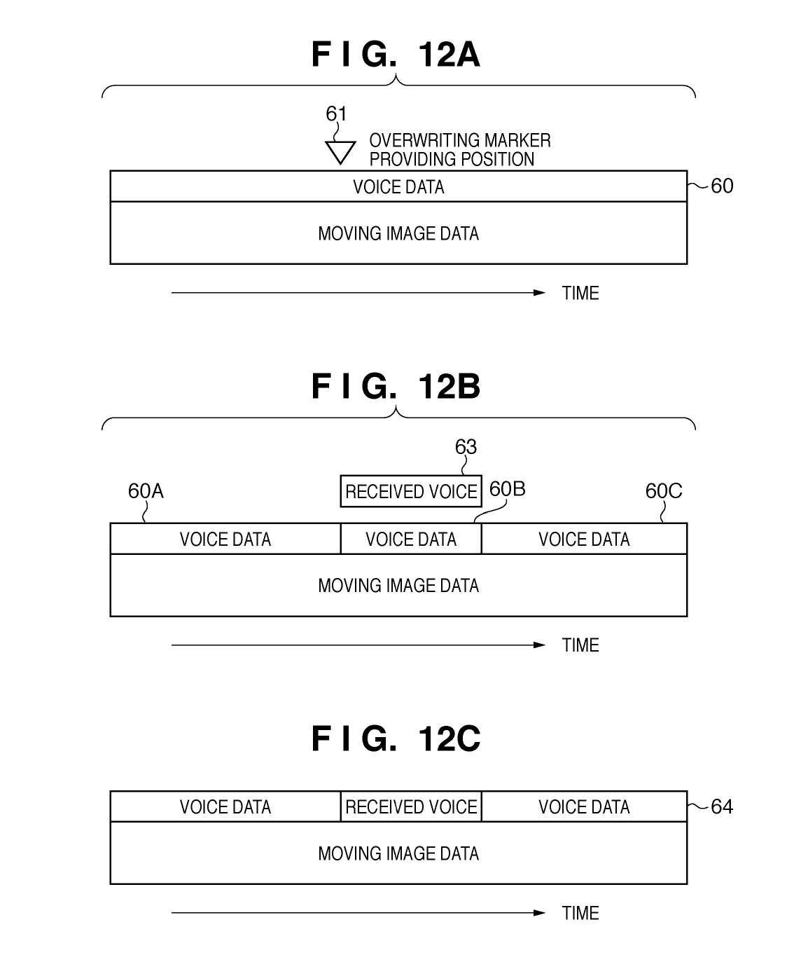

The providing of the overwriting marker to the voice data and the overwriting process of the voice data in the series of processes will be described in more detail with reference to FIGS. 12A to 12C. As illustrated in FIG. 12A, it is assumed that moving image data 70 and voice data 60 played back in synchronization with the moving image data 70 are selected in S500. The process is paused during the playback of the moving image data 70 and the voice data (S502). When the connection between the editing apparatus 1 and the other device 2 by the close proximity wireless communication is established (S503), an overwriting marker 61 is provided to the paused playback position (S504).

When the reception of dubbing voice data 63 from the other device 2 is finished, as shown in FIG. 12B, the voice data 60 is divided at the position of the overwriting marker 61 and at the position obtained by adding the playback time of the dubbing voice data 63 to the position of the overwriting marker 61. As a result, voice data 60A, 60B, and 60C are generated. As illustrated in FIG. 12C, the dubbing voice data 63 overwrites the voice data 60B started from the position of the overwriting marker 61 (S506).

A cross-fade process can be performed with the adjacent voice data 60A and 60C at the positions of both margins of the overwritten dubbing voice data 63. Although the dubbing voice data 63 overwrites the voice data 60 corresponding to the selected moving image data 70 in the description, the arrangement is not limited to this example. A mix process can be applied to the dubbing voice data 63 and the voice data 60 at a predetermined volume ratio.

Although the present third embodiment is applied to the dubbing process of the voice data in the description, the arrangement is not limited to this example. More specifically, the present third embodiment can be applied to the case in which moving image data is set as edit target data, and the edit target data is overwritten by the moving image data transmitted from the other device 2 from the overwriting marker position. The present third embodiment can also overwrite the moving image data as edit target data with a photo movie generated by converting the still image data transmitted from the other device 2 into moving image data from the overwriting marker position.

As described, according to the third embodiment of the present invention, an overwriting marker indicating the position for overwriting the voice data included in the editing apparatus 1 by the voice data included in the other device 2 is automatically set by approximating the other device 2 to the editing apparatus 1. As the insertion marker is set, the reception of the voice data transmitted from the other device 2 starts. Therefore, an operation of overwriting the voice data included in the editing apparatus 1 by the voice data included in the other device 2 can be easily performed.

Although the editing apparatus 1 is hardware having dedicated functions in the description, the arrangement is not limited to this example. For example, the editing apparatus 1 may have a close proximity wireless communication function and may be a personal computer installed with edit software for executing the processes described above.

### Fourth Embodiment

A fourth embodiment of the present invention will now be described. The present fourth embodiment is an example of applying the editing apparatus 1 described in the first to third embodiments and the modification example of the first embodiment to a digital video camera.

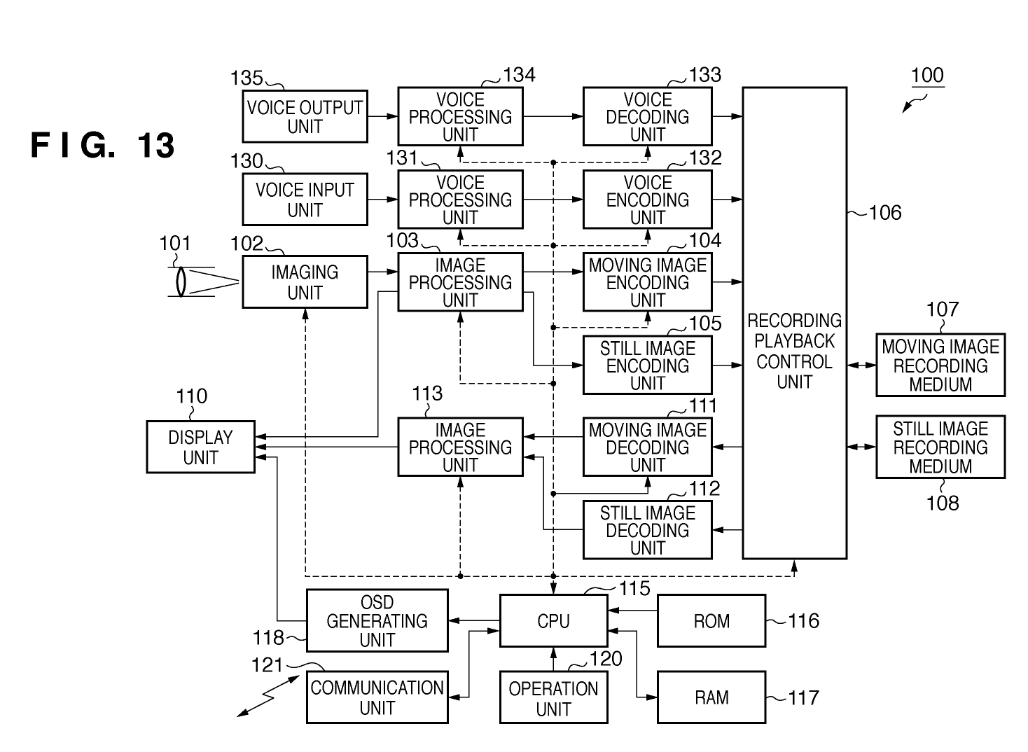

FIG. 13 shows an example of a configuration of a digital video camera 100 as an image pickup apparatus applicable to the fourth embodiment of the present invention. A CPU 115 controls the entire operation of the digital video camera 100. More specifically, the CPU 115 operates using a RAM 117 as a work memory in accordance with programs stored in a ROM 116 in advance and controls operations of the components of the digital video camera 100. The editing unit 16 described above is realized by the programs operated on the CPU 115. A block that functions as the editing unit 16, which the CPU 115 can control, may be newly arranged.

The operation unit 120 is equivalent to the operation unit 17 described above and includes various operation portions that receive user operations. The operation unit 120 outputs a control signal according to an operation to the operation portions and supplies the signal to a CPU 115. The CPU 115 can control the operation of the digital video camera 100 according to the control signal.

In accordance with an instruction of the CPU 115, an OSD generating unit 118 generates image data for OSD (On Screen Display) display on a display unit 110 equivalent to the display unit 11 described above. For example, the OSD generating unit 118 generates image data for displaying the list screens 20 and 50 for selecting moving image data to be edited and the menu screens 30 and 32 for setting voice input based on the instruction of the CPU 115. The image data for OSD display generated by the OSD generating unit 118 is supplied to a display unit 110 described below. Hereinafter, the image data for OSD display will be called OSD image data.

A configuration on the recording side will be described first. An optical system 101 as an image-sensing optical system includes an optical lens, a zoom mechanism, an auto focus mechanism, and an aperture mechanism. The CPU 115 controls the operations of the zoom mechanism, the auto focus mechanism, and the aperture mechanism.

An imaging unit 102 includes an imaging device, such as a CCD, that converts the light entering through the optical system 101 into an electric signal and a driving circuit that drives an imaging device to read out charges of the pixels. The imaging unit 102 further includes an image signal processing unit that applies a predetermined process to an image signal output from the imaging device to form image data. The driving circuit can continuously read out the charge from the image device at frame timing to generate moving image data.

The moving image data output from the imaging unit 102 is supplied to an image processing unit 103. The image processing unit 103 applies predetermined signal processing, such as gamma correction, noise reduction process, white balance process, and image quality correction process, to the moving image data output from the imaging device. The moving image data applied with the signal processing by the image processing unit 103 is supplied to a moving image encoding unit 104, a still image encoding unit 105, and the display unit 110.

The moving image data supplied from the image processing unit 103 and the OSD image data supplied from the OSD generating unit 118 are supplied to the display unit 110. The display unit 110 includes a display control unit, a display device such as an LCD, and a driving circuit of the display device. The moving image data for displaying monitor images during photographing, etc., and the OSD image data are combined and displayed in one screen on the display unit 110.

The moving image encoding unit 104 compresses and encodes the moving image data supplied from the image processing unit 3 with a predetermined compression encoding system and outputs the data. An MPEG 2 system, an H.264|AVC system, etc., can be applied as the compression encoding system. The compressed moving image data compressed and encoded by the moving image encoding unit 104 is supplied to a recording playback control unit 106.

Based on an instruction from the CPU 115, the image processing unit 103 can extract designated frames from the moving image data supplied from the imaging unit 102 and output still image data with the frames. The still image data is supplied to the still image encoding unit 105. Still image data from an image processing unit 113 described below is also supplied to the still image encoding unit 105. The still image encoding unit 105 compresses and encodes the supplied still image data with a predetermined compression encoding system and outputs the data. A JPEG system, etc., can be applied as the compression encoding system. The compressed still image data compressed and encoded by the still image encoding unit 105 is supplied to the recording playback control unit 106.

The image processing unit 103, the moving image encoding unit 104, the still image encoding unit 105, and the recording playback control unit 106 are equivalent to the recording processing unit 13 described above.

A voice input unit 130 corresponds to the voice input unit 19 described above and includes a voice input device such as a microphone, a line input terminal that inputs an analog or digital voice signal, etc. The voice input unit 130 can convert an analog voice signal output based on the voice collected by the voice input device and an analog voice signal inputted from the line input terminal into a digital voice signal. The digital voice signal output from the voice input unit 130 is applied to a voice processing unit 131 equivalent to the voice processing unit 14. The digital voice signal is supplied with predetermined voice signal processing, such as noise reduction, sound quality correction, and level adjustment, and is supplied to a voice encoding unit 132.

The voice encoding unit 132, included in the recording processing unit 13 described above, compresses and encodes the supplied digital voice signal with a predetermined compression encoding system and outputs the signal. In this case, the voice encoding unit 132 compresses and encodes the digital voice signal so that the signal can be synchronized with the moving image data compressed and encoded by the moving image encoding unit 104. Applicable compression encoding systems include MP3 and AAC. The MP3 is an abbreviation of Moving Pictures Experts Group 1 Audio Layer 3. The AAC is an abbreviation of Advanced Audio Coding. The compressed voice data output from the voice encoding unit 132 is supplied to the recording playback control unit 106.

In accordance with an instruction of the CPU 115, the recording playback control unit 106 controls reading and writing of data to the moving image recording medium 107 and the still image recording medium 108. For example, the recording playback control unit 106 controls the moving image recording medium 107 to record the compressed moving image data supplied from the moving image encoding unit 104 and controls the still image recording medium 108 to record the compressed still image data supplied from the still image encoding unit 105. The recording playback control unit 106 associates the compressed voice data supplied from the voice encoding unit 132 with corresponding compressed moving image data and records the data in the moving image recording medium 107.

Examples of recording media applicable as the moving image recording medium 107 and the still image recording medium 108 include, without particular limitation, a detachable non-volatile memory, a disk recording medium, and a hard disk that is detachable or embedded in the digital video camera 100. The moving image recording medium 107 and the still image recording medium 108 may also be different areas in the same recording medium. For example, the moving image recording medium 107 is equivalent to the recording medium 10 described above.

A configuration of the playback side will be described. Based on an instruction from the CPU 115, the recording playback control unit 106 reads out the designated compressed moving image data from the moving image recording medium 107 and supplies the data to a moving image decoding unit 111. The moving image decoding unit 111 decodes the supplied compressed moving image data in accordance with the encoding system upon recording to form baseband moving image data. The baseband moving image data is supplied to the image processing unit 113, and a predetermined image adjustment process, such as color tone correction, contrast adjustment, and sharpness (edge enhancement) process, is applied. For example, the CPU 115 controls the image adjustment in accordance with an operation to the operation unit 120. The moving image data output from the image processing unit 113 is supplied to the display unit 110, combined with the OSD image data supplied from the OSD generating unit 118 as necessary, and displayed.

In the same way as the image processing unit 103 described above, based on an instruction from the CPU 115, the image processing unit 113 can extract designated frames from the moving image data supplied from the moving image decoding unit 111 and output still image data with the frames. The still image data is supplied to the still image encoding unit 105.

In the same way as the image processing unit 103 described above, the image processing unit 113 can extract image parameters from the frames of the moving image data supplied from the moving image decoding unit 111. The extracted image parameters are supplied to, for example, the CPU 115.

The still image data is also played back in the same way. More specifically, based on an instruction from the CPU 115, the recording playback control unit 106 reads out compressed still image data from the still image recording medium 108 and supplies the data to a still image decoding unit 112. The still image decoding unit 112 decodes the supplied compressed still image data in accordance with the encoding system upon recording to form baseband still image data. The baseband still image data is supplied to the image processing unit 113, applied with predetermined image processing as described above, and supplied to the display unit 110.

The image processing unit 113, the moving image decoding unit 111, the still image decoding unit 112, and the recording playback control unit 106 are equivalent to the playback processing unit 12 described above.

The voice data is also played back in the same way as the moving image data and the still image data. More specifically, based on an instruction from the CPU 115, the recording playback control unit 106 reads out compressed voice data from the moving image recording medium 107 and supplies the data to a voice decoding unit 133. The voice decoding unit 133 decodes the supplied compressed voice data in accordance with the encoding system upon recording to form baseband voice data. The baseband voice data is supplied to the voice processing unit 134, applied with predetermined signal processing, and supplied to a voice output unit 135. The voice output unit 135 converts a supplied digital voice signal into an analog voice signal and supplies the signal to a voice output device, such as a speaker. The digital voice signal or the analog voice signal can be output from a line.

The communication unit 121 is equivalent to the communication unit 18 described above and performs communication by the close proximity wireless communication. More specifically, the communication unit 121 includes an antenna for performing the close proximity wireless communication and a transmission/reception circuit that transmits and receives data by the close proximity wireless communication. The communication unit 121 is configured to be able to detect the connection and disconnection status of communication by the close proximity wireless communication, and the detected connection and disconnection status of communication is notified to the CPU 115.

With such a configuration, the compressed moving image data photographed by the imaging unit 102 and recorded in the moving image recording medium 107 is played back (S101 of FIG. 4), and the playback is paused at a desired position of the played back moving image data (S102 of FIG. 4). The other device 2 (such as a digital still camera) compliant to the close proximity wireless communication prepares, for example, still image data to be inserted into the moving image data paused in the digital video camera 100 so that the data can be transmitted by the close proximity wireless communication.

If the other device 2 is approximated to the communication unit 121 under the condition, an insertion marker corresponding to the paused playback position of the moving image data is set in the digital video camera 100 (S104 of FIG. 4). After the setting of the insertion marker, the still image data transmitted from the other device 2 is received by the communication unit 121 and transferred to the CPU 115. The CPU 115 supplies the transferred still image data to the recording playback control unit 106 and records the data in the still image recording medium 108. The still image data may be recorded in the moving image recording medium 107.

In the digital video camera 100, the CPU 115 creates a playlist including the information of the insertion marker (S201 of FIG. 5A) and starts measuring the connection time by the close proximity wireless communication (S203 of FIG. 5A). The playlist is stored, for example, in the RAM 117.

To input voice, the voice inputted to the voice input unit 130 is supplied to the voice encoding unit 132 through the voice processing unit 131, applied with a compression encoding process, and sequentially stored in a memory in the voice encoding unit 132 (S205 of FIG. 5A). When the communication unit 121 detects that the close proximity wireless communication is disconnected, the recording of voice ends. The CPU 115 associates the compressed voice data stored in the memory in the voice encoding unit 132 with the still image data received by the communication unit 121 and records the data, for example, in the moving image recording medium 107 (S208 of FIG. 5A).

The measurement of the connection time by the close proximity wireless communication ends (S209 of FIG. 5A), and the CPU 115 sets the connection time obtained as a result of the measurement as the playback time of the still image data (S210 of FIG. 5A). The CPU 115 then divides the moving image data to be edited at the position of the insertion marker on the playlist and inserts the still image data and the voice data received by the communication unit 121 into the divided position (S215 of FIG. 5B).

Based on the playlist, the CPU 115 plays back the moving image data inserted with the still image data and displays the data on the display unit 110 (S216 of FIG. 5B). Corresponding voice data can also be played back in synchronous with the moving image data, and the voice output unit 135 outputs the data. To update the playlist after the playback is confirmed, for example, the playlist stored in the RAM 117 is recorded in the moving image recording medium 107 (S218 of FIG. 5B).

In this way, according to the fourth embodiment, an operation of inserting the still image data transmitted from the other device 2 into a desired position of the moving image data photographed by the digital video camera 100 can be executed by approximating the other device 2 to the digital video camera 100. A process of inserting still image data supplied from another device into moving image data can be executed by a simple operation without using other devices such as a personal computer.

Although the editing apparatus 1 is a digital video camera in the description, the editing apparatus 1 may be a digital still camera or a stationary recorder.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-300186, filed on Nov. 25, 2008, which is hereby incorporated by reference herein its entirety.

What is claimed is:

1. An editing apparatus comprising:
an editing unit configured to edit data;
a communication unit configured to transmit and receive data to and from an external device by close proximity wireless communication; and
a detecting unit configured to detect a status of the connection with the external device by the close proximity wireless communication, wherein
if said detecting unit detects that the connection with the external device is established while said editing unit edits first data, said communication unit receives second data from the external device, and said editing unit incorporates the second data received by said communication unit into the first data.

2. The editing apparatus according to claim 1, further comprising
a providing unit configured to provide to data to be edited a marker indicating a position from which another data are to be incorporated into the data to be edited, wherein
said providing unit provides the marker to the first data when said detecting unit detects that the connection with the external device is established while said editing unit edits the first data, and
said editing unit incorporates the second data received by said communication unit from the external device into the first data from the position indicated by the marker.

3. The editing apparatus according to claim 2, wherein
if said detecting unit detects that the connection with the external device is established while a playback of the first data is being paused, said providing unit provides the marker to the position of the first data where the playback of the first data is paused.

4. The editing apparatus according to claim 2, wherein
if said detecting unit detects that the connection with the external device is established while the first data is being played back, said providing unit pauses the playback of the first data and provides the marker to the position where the playback of the first data is being paused.

5. The editing apparatus according to claim 2, wherein
if the first data is moving image data and the second data is still image data,
said editing unit incorporates the second data into the first data so that a playback time of the incorporated second data is equal to the time period between a time when said detecting unit detects that the connection with the external device is established and a time when said detection unit detects that the connection with the external device is disconnected.

6. The editing apparatus according to claim 5, wherein
said editing unit incorporates the second data into the first data without modifying the first data by employing a playlist that manages the order of playback of data.

7. The editing apparatus according to claim 6, wherein
said editing unit incorporates the second data into the first data by including, in the playlist, a description indicating that the second data is to be played back for the playback time in the middle of the playback of the first data and that the first data and the second data are to be continuously played back.

8. The editing apparatus according to claim 5, wherein
said editing unit converts the second data into moving image data with a length of the playback time and the same format as the first data, and then incorporates the movie data converted from the second data into the first data.

9. The editing apparatus according to claim 5, wherein
said editing unit:
converts the second data into moving image data with a length of the playback time and the same format as the first data;
divides the first data at the position of the marker; and
inserts the moving image data converted from the second data into the divided position in order to incorporate the second data into the first data.

10. The editing apparatus according to claim 5, further comprising
a voice data acquisition unit configured to acquire voice data, wherein
said editing unit associates and stores the voice data acquired by said voice data acquisition unit and the second data from a timing when said detecting unit detects that the connection with the external device is established to a timing when said detecting unit detects that the connection with the external device is disconnected.

11. The editing apparatus according to claim 5, wherein
said editing unit stores prepared voice data and the second data by associating with each other.

12. The editing apparatus according to claim 1, wherein
the first and second data are moving image data, and
said editing unit incorporates the second data into the first data without modifying the first data by employing a playlist that manages the order of playback of data.

13. The editing apparatus according to claim 2, wherein
the first and second data are moving image data, and said editing unit incorporates the second data into the first data by dividing the first data at the position of the marker and then inserting the second data into the divided position of the first data.

14. The editing apparatus according to claim 2, wherein
said editing unit incorporates the second data into the first data by overwriting the first data with the second data from the position of the marker.

15. The editing apparatus according to claim 14, wherein
the first data includes voice data, the second data is voice data, and
said editing unit incorporates the second data into the first data by overwriting the voice data included in the first data with the second data from the position of the marker.

16. A control method of an editing apparatus, the editing apparatus comprising:
an editing unit configured to edit data;
a communication unit configured to transmit and receive data to and from an external device by close proximity wireless communication; and
a detecting unit configured to detect the status of connection with the external device, the control method comprising,
if said detecting unit detects that the connection with the external device is established while said editing unit edits first data:
a step of said communication unit receiving second data from the external device; and
a step of said editing unit incorporating the second data received by said communication unit into the first data.

17. A computer-readable recording medium recording a program for causing a computer to function as the editing apparatus of claim 1.

18. An image pickup apparatus comprising:
an image pickup unit configured to photograph light entering through an image-sensing optical system and output the light as an image signal;
a voice processing unit configured to convert collected voice into voice data and output the voice data;
a recording unit configured to record moving image data based on the image signal obtained using said image pickup unit and voice data output from said voice processing unit in a recording medium;
a playback unit configured to play back at least one of the moving image data and the voice data from the recording medium;
an editing unit configured to edit data;
a communication unit configured to transmit and receive data to and from an external device by close proximity wireless communication; and
a detecting unit configured to detect a status of the connection with the external device, wherein
if said detecting unit detects that the connection with the external device is established while said editing unit edits at least one of the moving image data and the voice data recorded in the recording medium, said communication unit receives data from the external device, and said editing unit incorporates the data received by said communication unit into the data being edited.
